(19) United States
(12) Patent Application Publication
(10) Pub. No.: US 2011/0129706 A1
(43) Pub. Date: Jun. 2, 2011

(54) Lithium-Ion Secondary Battery

(75) Inventors: Kazuo TAKAHASHI, Hitachiota-shi (JP); Hidekazu Fujimura, Mito-shi (JP); Ko Takahashi, Tokyo (JP); Yoshimi Yanai, Kitaibaraki-shi (JP)

(73) Assignee: Hitachi, Ltd., Tokyo (JP)

(21) Appl. No.: 12/857,951

(22) Filed: Aug. 17, 2010

(30) Foreign Application Priority Data
Nov. 30, 2009 (JP) 2009-270962

(51) Int. Cl. H01M 10/50; H01M 4/24

(52) U.S. Cl. 429/94

(57) ABSTRACT

A lithium-ion secondary battery includes: a winding body in a coil formation at a battery container, the winding body wrapping a cathode film in which lithium ions store and from which lithium ions extract and a anode film in which lithium ions store and from which lithium ions extract, and the cathode film and the anode film being electrically separated from each other via a porous separator; and a heat sink disposed inside the battery container, which contacts the battery container and transmits heat inside the winding body to the battery container.

### INCORPORATION BY REFERENCE

The disclosure of the following priority application is herein incorporated by reference:

Japanese Patent Application No. 2009-270962 filed Nov. 30, 2009

### BACKGROUND OF THE INVENTION

1. Field of the Invention

The present invention relates to a lithium-ion secondary battery, and more specifically, it relates to a lithium-ion secondary battery that allows heat generated within the battery to be efficiently dissipated.

2. Description of Related Art

Lithium-ion secondary batteries, which provide greater electromotive force with higher energy density while assuring superior electrical charge/discharge efficiency compared to lead-acid batteries and nickel-metal hydride batteries, are considered to be a promising for use in a wide range of applications, both as compact portable batteries and as large batteries for automotive use and electric power storage.

However, lithium-ion secondary batteries are also known to generate heat due to a reaction occurring during charge/discharge or battery internal resistance, and, particularly the temperature inside a high-output battery is known to rise to a high level. If the high-temperature condition is sustained over an extended period of time, the service life of the battery will be reduced or the battery itself will be degraded. Under such circumstances, the specific output requirement can no longer be assured.

In order to address this issue, the following means for cooling the inside of the battery have been proposed.

Japanese Laid Open Patent Publication No. 2000-260474 discloses a structure that includes a heat pipe inserted at a center pin located at a substantial center of a battery container (can) and extending to the outside of the battery, through which heat generated within the battery is released to the outside of the battery.

Japanese Laid Open Patent Publication No. 2002-352863 discloses a structure equipped with a cooling means for cooling an electric current path having an external terminal. The publication proposes that a gas or a liquid may be used as a cooling medium and also suggests the use of a cooling device that uses electricity, gas or the like as an energy source thereof.

Japanese Laid Open Patent Publication No. 2007-311374 discloses a structure that includes a heat-absorbing portion taking up a position over part of a center pin located in an electrode winding area and constituted with an organic glue assuming a higher specific heat relative to the specific heat at the center pin, so as to dissipate heat having been generated in the battery by absorbing the heat both through the heat absorbing portion and the center pin.

### SUMMARY OF THE INVENTION

However, while the structure, which includes a heat pipe inserted at a substantial center of the battery container (can) with a cooling medium originating from an external source circulating through the heat pipe, assures a high level of cooling effect, it requires a cooling medium forced-circulation line to be laid out in correspondence to each battery. In addition, an integrated system constituted with a plurality of such batteries may be subject to significant restrictions with regard to the positional arrangement with which the batteries may be disposed.

In addition, while the structure with a cooling means for directly cooling the electric current path through which heat is also transmitted, assures a high level of cooling efficiency and superior battery volumetric efficiency, heat is dissipated only over a battery electrode terminal and thus, the structure requires forced cooling. In addition, as the electrode terminal is cooled directly, static electricity is generated, which, in turn, causes ready adhesion of suspended minute particulates, to lead to corrosion of the electrode terminal.

The heat-absorbing portion, assuming a greater specific heat than that at the center pin, will be effective in holding back a rise in temperature within the battery as a predetermined length of time elapses. However, the heat-absorbing response will become poor in an operating environment with significant output fluctuation or an operating environment where steep charge/discharge is repeated and thus, it may not be possible to keep the battery temperature at the desired level in such an operating environment.

Accordingly, an object of the present invention is to provide a lithium-ion secondary battery that allows heat generated within the battery to be efficiently transmitted to the container so as to prevent deterioration of the battery characteristics attributable to high temperatures, without drastically altering the battery structure.

According to the 1st aspect of the present invention, a lithium-ion secondary battery comprising: a winding body in a coil formation at a battery container, the winding body wrapping a cathode film in which lithium ions store and from which lithium ions extract and a anode film in which lithium ions store and from which lithium ions extract, and the cathode film and the anode film being electrically separated from each other via a porous separator; and a heat sink disposed inside the battery container, which contacts the battery container and transmits heat inside the winding body to the battery container.

According to the 2nd aspect of the present invention, it is preferred that the lithium-ion secondary battery according to the 1st aspect further comprises: a center pin constituted of a material similar to a material constituting the heat sink, which is located at a center of the winding body.

According to the 3rd aspect of the present invention, it is preferred that the lithium-ion secondary battery according to the 2nd aspect further comprises: an anode collector ring disposed between the center pin and the heat sink, constituted of a material similar to the material constituting the center pin and the heat sink, and connected to an anode tab.

According to the 4th aspect of the present invention, it is preferred that in the lithium-ion secondary battery according to the 3rd aspect, an area over which the heat sink contacts the anode collector ring is greater than an area over which the center pin contacts the anode collector ring.

According to the 5th aspect of the present invention, the lithium-ion secondary battery according to the 1st aspect may further comprise: a top cap connected, via an electrically insulating packing, to the battery container; and a cathode collector ring electrically connected to the top cap via a cathode connecting member and connected to a cathode tab.

According to the 6th aspect of the present invention, the lithium-ion secondary battery according to the 5th aspect may further comprise: an electrically insulating connecting ring that is connected to the cathode collector ring and the center pin.

According to the 7th aspect of the present invention, the lithium-ion secondary battery according to the 1st aspect may further comprise: a center pin located at a center of the winding body and constituted of a material with a high coefficient of thermal conductivity, and it is preferred that the center pin and the heat sink are connected.

According to the 8th aspect of the present invention, it is preferred that in the lithium-ion secondary battery according to the 7th aspect, the cathode film, the anode film and the separator wind around the center pin.

According to the 9th aspect of the present invention, a lithium-ion secondary battery, comprises: a winding body that wraps a cathode film and an anode film via a separator, the cathode film including electrode layers and a cathode collector portion with no electrode layer formed thereat disposed on a side along a widthwise direction, the anode film including electrode layers and an anode collector portion with no electrode layer formed thereat disposed on another side along a widthwise direction, and the separator electrically separating the cathode film and the anode film from each other; a battery canister accommodating the winding body, which includes an anode external terminal connected with the anode collector portion and a cathode external terminal connected with the cathode collector portion; a center core ranging at a central area of the winding body; and a heat sink disposed at one end of the center pin and connected to an inner surface of the battery canister.

According to the 10th aspect of the present invention, the lithium-ion secondary battery according to the 9th aspect may further comprise: an insulating member disposed at another end of the center pin and connected to the inner surface of the battery canister.

According to the present invention, heat generated inside the battery container be transferred to the battery container with high efficiency and thus, in the battery characteristics attributable to high temperatures can be effectively prevented without having to drastically alter the battery structure.

### BRIEF DESCRIPTION OF THE DRAWINGS

FIG. 1 is a schematic sectional view of a cylindrical lithium-ion secondary battery.

FIG. 2 is a schematic illustration of the angular lithium-ion secondary battery achieved in embodiment 2.

FIG. 3 is a schematic lateral sectional view of the angular lithium-ion secondary battery achieved in embodiment 2.

FIG. 4 is an exploded perspective of the angular lithium-ion secondary battery achieved in embodiment 3.

FIG. 5 is a lateral sectional view of the lithium-ion secondary battery achieved in embodiment 3.

FIG. 6 is a perspective showing the center pin of the lithium-ion secondary battery achieved in embodiment 3.

FIG. 7 is a prospective showing the winding body of the lithium-ion secondary battery achieved in embodiment 3.

### DESCRIPTION OF PREFERRED EMBODIMENTS

Lithium-ion secondary batteries are provided in various forms such as a button form, a cylinder form, a prismatic form and a laminated form, so as to meet the requirements of diverse applications.

The lithium-ion secondary battery according to the present invention, with a winding body that winds in a coil form around a cathode foil (cathode film) and an anode foil (anode film) electrically separated from each other via a separator, may be provided as a cylindrical lithium-ion secondary battery or a prismatic lithium-ion secondary battery.

The following is a detailed description of a cylindrical lithium-ion secondary battery achieved as embodiment 1 and a prismatic lithium-ion secondary battery achieved as embodiment 2.

### Embodiment 1

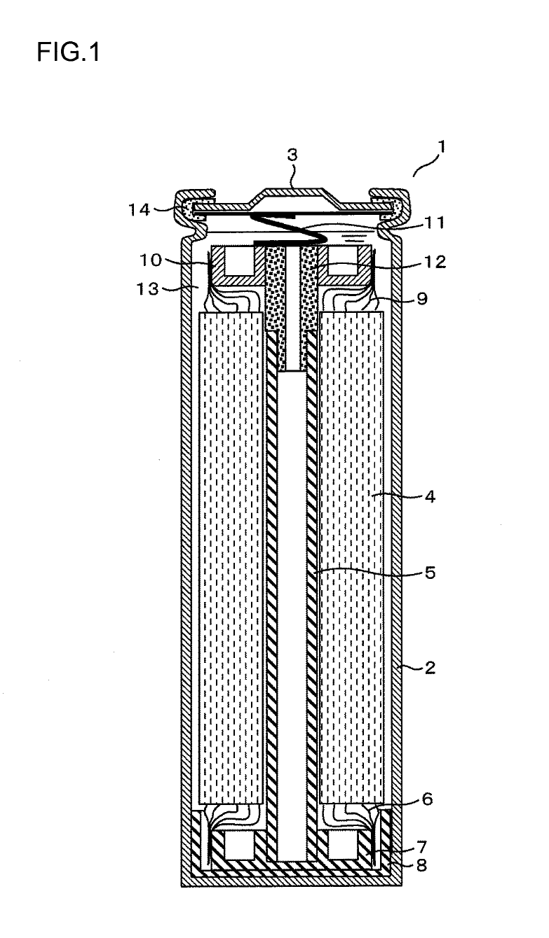

FIG. 1 is a schematic sectional view of the cylindrical lithium-ion secondary battery achieved in embodiment 1.

A lithium-ion secondary battery 1 in the embodiment includes a winding body 4 accommodated in the space formed by a steel-can (container) 2 and a top cap 3 and assumes a structure that allows heat generated at the winding body 4 during electrical charge/discharge to be dissipated to the outside by transmitting the heat to the steel-can 2.

It is to be noted that the winding body 4 is wrapped in a coil form around a cathode foil (cathode film) and an anode foil (anode film) via a porous separator that electrically separates them. In the cathode foil and the anode foil lithium ions can store and from the cathode foil and anode foil lithium ions can extract.

A center pin 5 is fitted at the center of the winding body 4, wound in a spiral form around the cathode electrode and the anode electrode, separated via the separator.

Numerous anode tabs 6 at the anode electrode of the winding body 4 extend toward the bottom side of the steel-can 2. The numerous anode tabs 6 are connected to the outer circumference of an anode collector ring 7 connected to the center pin 5. The anode collector ring 7 is also connected to a heat sink 8 disposed at the bottom of the steel-can 2.

Numerous cathode tabs 9 at the cathode electrode of the winding body 4 extend toward the top cap 3. The numerous cathode tabs 9 are connected to the circumference of a cathode collector ring 10. The cathode collector ring 10 is fixed to the center pin 5 via a connecting ring 12 having an electrically insulating property.

In addition, the cathode collector ring 10 is connected via a cathode connecting member 11 to the top cap 3 which also functions as a cathode external terminal.

The members constituting the lithium-ion secondary battery are now described in further detail.

The steel-can 2 is made of nickel-plated steel. A copper heat sink 8 is installed in advance at the bottom of the steel-can 2. The heat sink 8, formed in a cylindrical shape so as to come into contact with the bottom of the steel-can 2 and part of the side surface, is inserted in the steel-can 2 and expanded from the inside with a roller so as to be in tight contact with the steel-can 2 for a reliable fit.

It is to be noted that the heat sink 8, which lies in contact with part of the side surface of the steel-can 2, is structurally required to assume a position lower than the installation position at which the winding body 4 is disposed.

In addition, the heat sink 8 contacts the anode collector ring 7 over an area greater than the area over which the center pin 5 contacts the anode collector ring 7, and the heat sink 8, the center pin 5 and the anode collector ring 7 are constituted of similar materials.

The cathode electrode at the winding body 4 is manufactured by coating the two surfaces of a rectangular aluminum foil with a cathode electrode active material constituted of a lithium transition metal complex oxide.

The anode negative electrode at the winding body 4 is manufactured by coating the two surfaces of a rectangular copper foil with an anode electrode active material constituted of carbon.

Neither the cathode electrode active material nor the anode electrode active material can be applied by itself and accordingly, they are each applied in the form of a slurry prepared by adding a binder constituted of polyvinylidene fluoride (PVDF) and a dispensing catalyst constituted of N-methyl-2-pyrrolidone (NMP).

Once the active materials have been applied and have dried, each electrode is formed by pressing the foil to achieve a predetermined density level with a press machine.

The separator may be constituted with a slightly porous film achieving a porosity rate of, for instance, 45%, which may assume a triple layer structure constituted of polypropylene/polyethylene/polypropylene.

The hollow center pin 5, which is constituted of copper, is formed so as to assume a greater length on the side where the anode tabs 6 are formed relative to the length of the winding body 4 and assume a smaller length on the site where the cathode tabs 9 are formed relative to the length of the winding body 4.

The anode electrode-side of the center pin 5 is connected to the central area of the copper anode collector ring 7 so as to hold fast the anode collector ring 7. The plurality of anode tabs 6 are welded to the circumference of the anode collector ring 7 with an ultrasound welder.

The connecting ring 12 constituted of polypropylene is fixed to the cathode electrode-side of the center pin 5, with the cathode collector ring 10 constituted of aluminum fixed to the connecting ring 12.

Once the assembled winding body 4 has been inserted through and connected to the steel-can 2 with the heat sink 8 attached thereto, the cathode collector ring 10 and the top cap 3 are connected via the cathode connecting member 11 formed by stacking a plurality of aluminum foils one on top of another.

The top cap 3 functions as an aluminum cleavage valve that splits when the internal pressure rises to an abnormally high level. It is connected to the cathode electrode-side of the winding body 4 via the cathode connecting member 11 and also acts as a cathode external terminal.

The steel-can 2, filled with an electrolyte 13, and the top cap 3 are connected with each other via an electrically insulating packing (gasket) 14, and the steel-can 2 and the top cap 3 are sealed together as the steel-can 2 is caulked with a caulking instrument.

Next, the advantages of the lithium-ion secondary battery 1 achieved in embodiment 1 are described.

Heat generated inside the battery during electrical charge/discharge is attributable to either the battery internal resistance or the chemical reactions between the electrolyte and the active materials occurring under abnormal conditions in the battery such as an overcharge.

When heat is generated due to the battery internal resistance, the temperature tends to increase in a central area of the battery where the heat discharge characteristics are poorer.

In the case of heat generation attributable to the chemical reaction, heat is generated and the temperature thus rises over a localized area where the reaction is occurring.

The heat generated as described above can be dissipated with high efficiency by assuming a large heat transfer area and by creating a large temperature difference through forced cooling.

The embodiment features a heat sink 8 structured to achieve a large heat transfer area. The embodiment is characterized as follows. The heat generated in the center of the battery is transmitted to the copper center pin 5 assuring good thermal conductivity, the heat having been transmitted to the center pin 5 is then transmitted to the anode collector ring 7 with a large heat transfer area, the heat having been transmitted to the anode collector ring 7 is then transferred to the heat sink 8 with a large heat transfer area and the heat is finally released through the surface of the steel-can 2 in contact with the heat sink 8.

In addition, when the lithium-ion secondary battery 1 is used in a certain operating environment, natural cooling of the steel-can 2 may not occur. In such a case, the area of the steel-can 2 that is in contact with the heat sink 8 should be forcibly cooled so as to allow the entire battery to cool down.

### Embodiment 2

While the lithium-ion secondary battery according to the present invention is provided as a cylindrical lithium-ion secondary battery 1 in embodiment 1, the present invention is not limited to this battery shape and may be adopted in a prismatic battery or another polygonal battery as long as the battery includes a winding body.

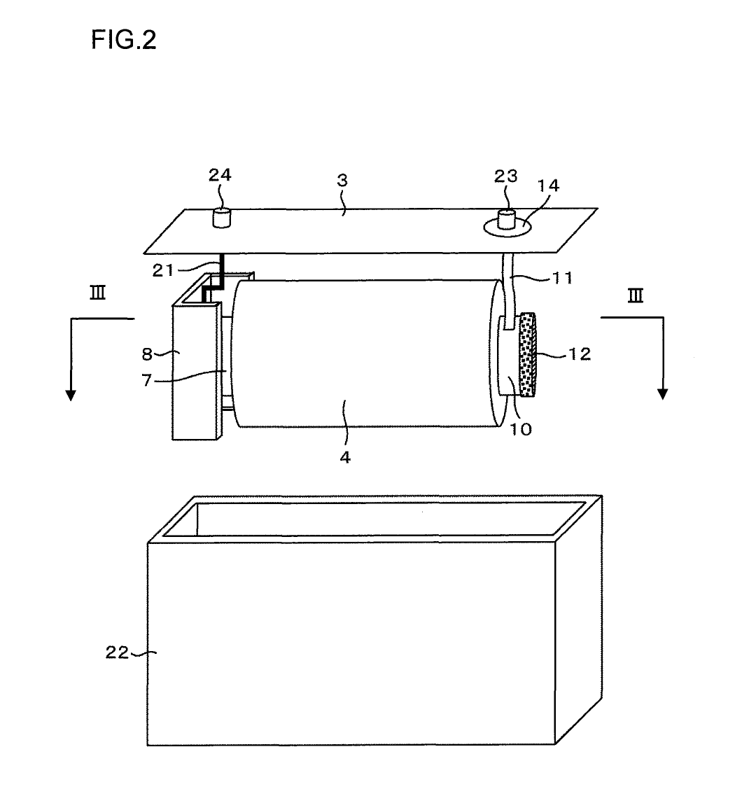

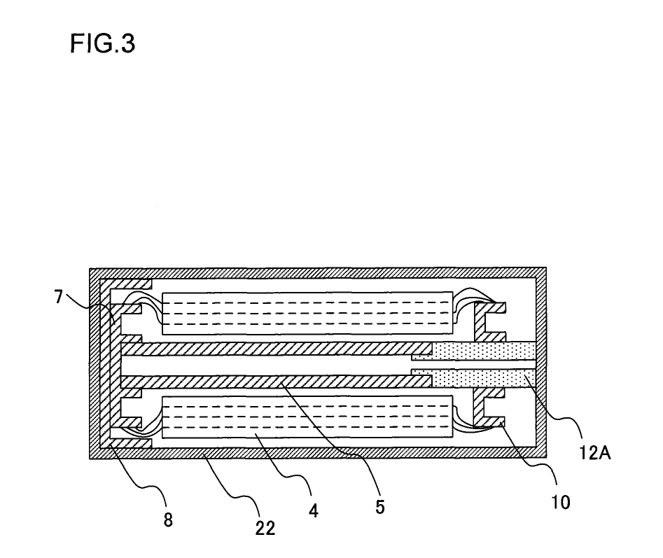

In reference to FIGS. 2 and 3, the prismatic lithium-ion secondary battery achieved in embodiment 2 is described in detail. FIG. 2 is an external view of the prismatic lithium-ion secondary battery achieved in embodiment 2, whereas FIG. 3 is a sectional view of the prismatic lithium-ion secondary battery in FIG. 2 taken through line III-III.

The prismatic lithium-ion secondary battery in the embodiment includes a flat winding body 4 disposed with a lateral orientation, with the anode electrode located on the left side of the figures and the cathode electrode located on the right side of the figures.

The winding body 4 in the embodiment wraps in a spiral form around a cathode electrode and an anode electrode via a separator, with an elliptical center pin 5 built into the center of the winding body 4.

On the anode electrode-side of the winding body 4, an anode collector ring 7 is mounted at the center pin 5, with a heat sink 8 attached to the anode collector ring 7.

The heat sink 8 is formed so as to contact inner side surfaces of a battery container of box type 22.

The center pin 5, the anode collector ring 7 and the heat sink 8 are all constituted of copper, assuring good thermal conductivity.

The anode collector ring 7 and an anode terminal 24 connected with a top cap 3 are connected with each other via a rigid anode connecting member 21 constituted of copper.

On the cathode electrode-side of the winding body 4, an electrically insulating connecting member 12A fitted within an aluminum cathode collector ring 10 is connected with the center pin 5.

The connecting member 12A is formed to assume a greater length relative to the length of the cathode collector ring 10 and will not be shorted even as it comes in contact with the battery container of box type 22.

The cathode collector ring 10 and a cathode terminal 23 are connected via a flexible cathode connecting member 11 formed by stacking a plurality of aluminum foils one on top of another.

The cathode terminal 23 located at the top cap 3 is mounted via a gasket 14 to assure electrical insulation. The battery container of box type 22 accommodates the winding body 4 with the heat sink 8 attached thereto, which is an integrated part of the top cap 3. The battery container of box type 22 filled with an electrolyte is sealed by welding the circumference of the top cap 3 with a laser. Subsequently, an electrolyte is poured into the battery container of box type 22 through a filler port (not shown) and the filler port is then sealed. The complete prismatic lithium-ion battery is manufactured through the sequence described above.

Advantages of the prismatic lithium-ion secondary battery achieved in embodiment 2 are now described.

At the prismatic lithium-ion secondary battery achieved in the embodiment, heat generated during electrical charge/discharge is transmitted from the center pin 5 fitted at the center of the winding body 4 to the heat sink 8 via the anode collector ring 7 and the heat is thus effectively dissipated from the battery container of box type 22.

In addition, since the anode electrode-side of the winding body 4 is supported with the center pin 5, the anode collector ring 7 and the heat sink 8 and the cathode electrode-side of the winding body 4 is supported with the electrically insulating connecting member 12A, a robust battery structure that is not vulnerable to vibration or shock is achieved.

The primary concept based upon which the object of the present invention is achieved, demonstrated in embodiment 1 and embodiment 2, is as follows.

The present invention, related to a lithium-ion secondary battery which includes a winding body that is wrapped in a coil form or an elliptical coil form around a cathode foil (cathode film) and an anode foil (anode film) electrically separated from each other via a separator, is characterized in that a thermally conductive member is disposed in a path extending from the axial center of the winding body to the heat dissipating portion of the steel-can or the battery container (hereafter, container).

It is further characterized in that the heat transfer area of the thermally conductive member becomes greater as the distance from the axial center at the winding body becomes larger, i.e., closer to the container. Through these measures, improved heat dissipation efficiency is achieved.

It is further characterized in that the heat dissipating portion in contact with the container is constituted as a terminal surface on the anode electrode-side and a side surface of the container. This feature also makes it possible to improve the heat dissipation efficiency.

In addition, a cooling means for forcibly cooling the battery from the side surface of the container may be disposed at the heat dissipating portion in contact with the container.

The embodiments are both characterized in that instead of simply setting the center pin in contact with the container, a heat sink is utilized to effectively dissipate heat.

Namely, in order to dissipate the internal heat to the outside with a high level of efficiency, the heat must be transmitted from the center pin to the heat dissipating surface and a large temperature difference between the heat dissipating surface and the atmosphere must be maintained. While good heat transfer can be effectively assured by creating a large heat transfer area, the coefficient of thermal conductivity inherent to the material, too, is a crucial factor.

The container must have a specific level of strength and for this reason, a steel (iron group) material or aluminum is routinely used to constitute the container. While the container may be formed to achieve a large wall thickness at the bottom thereof so as to use the bottom of the container as a heat sink, the container and the heat sink will need to be constituted of the same material in such a case. When this structure is adopted in conjunction with aluminum, the coefficient of thermal conductivity around room temperature will be approximately 2.8 times that of iron, whereas when this structure is adopted in conjunction with copper, the coefficient of thermal conductivity around room temperature will be as much as approximately 4.7 times that of iron.

However, the wall thickness of the container constituted of copper, with a large coefficient of thermal conductivity will have to be significant in order to assure the desired strength, which may lead to lowered weight energy density.

For this reason, the heat sink in the embodiments is constituted of a different material from that used to form the container.

The container and the heat sink, formed with different materials as described above, fulfill different roles. Namely, the container constituted of thin steel sheet assures a sufficient level of strength, whereas the heat sink and the center pin constituted of copper assure good heat dissipation characteristics. Since the temperature inside the battery is sustained at the optimal level as a result, the service life of the battery is maximized and desirable battery performance can be maintained.

It is to be noted that the winding body 4 may have no center pin 5. In this case, for example, the heat sink 8 is configured to connect both the winding body 4 and the container.

### Embodiment 3

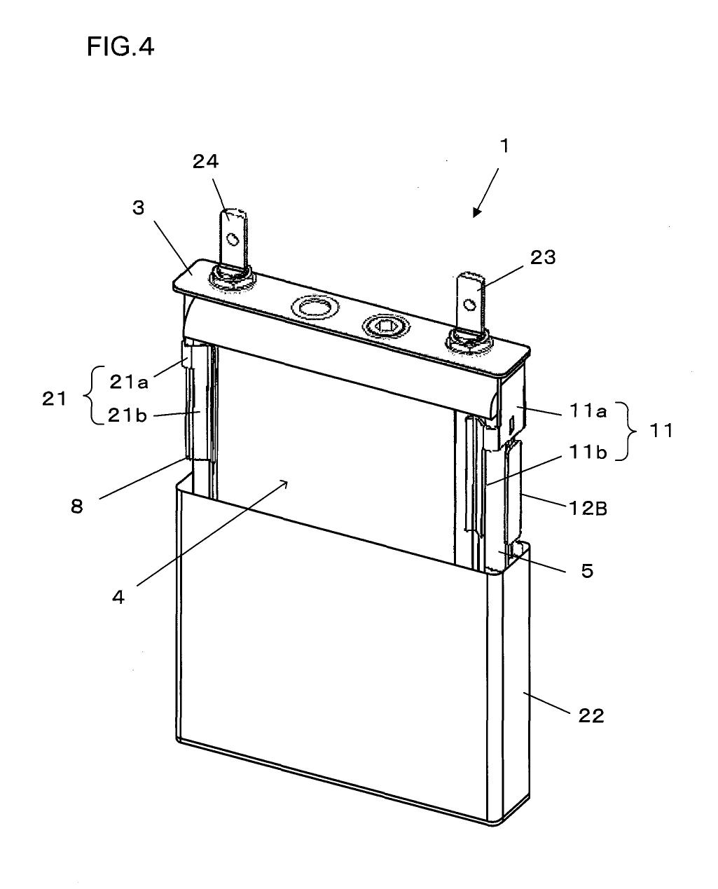

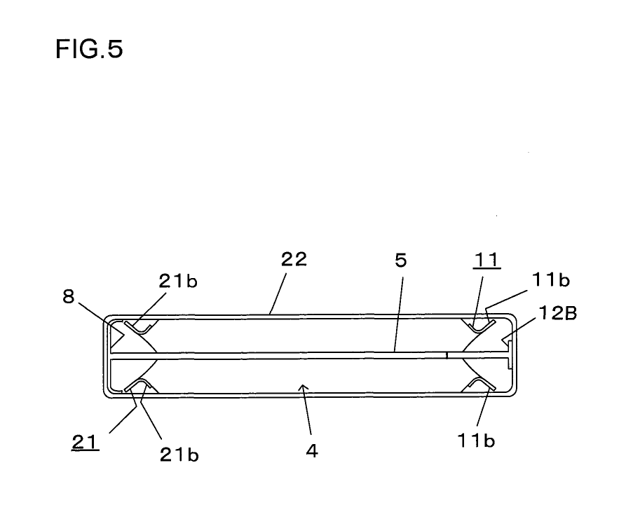

In reference to FIGS. 4 through 7, the prismatic lithium-ion secondary battery achieved in embodiment 3 is described. It is to be noted that the same reference numerals are assigned to parts identical to or equivalent to those in embodiment 2 and the following explanation focuses on the features distinguishing embodiment 3 from embodiment 2. The lithium-ion secondary battery achieved in embodiment 3 is ideal in automotive applications.

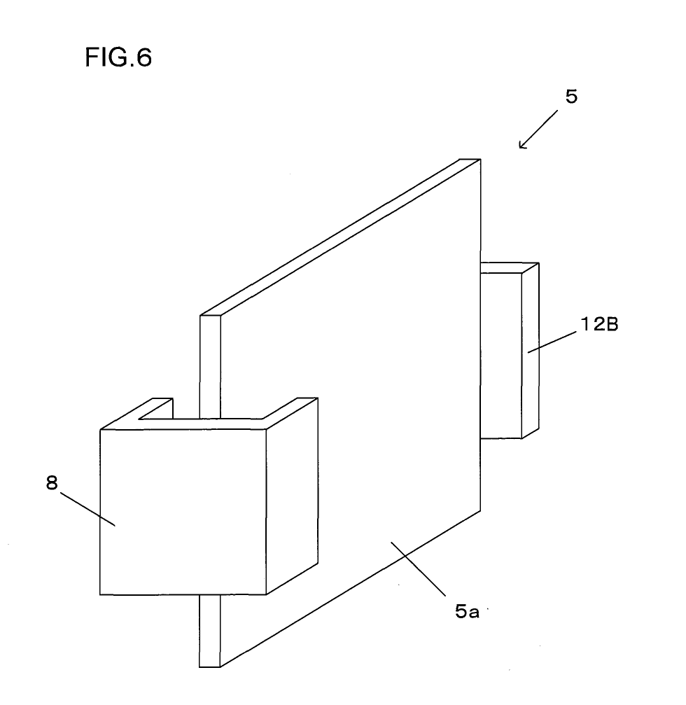

In the description of the lithium-ion secondary battery 1 achieved in embodiment 3, a battery container of box type 22 sealed with the top cap 3 as shown in FIG. 4 is referred to as a battery canister. The lithium-ion secondary battery 1 includes a center pin (center core) 5 formed as an integrated flat plate. As shown in FIG. 6, the center pin 5 is formed as an integrated unit that includes a center pin body 5a, a heat sink 8 connected to the center pin body 5a at an anode electrode-side end thereof and a connecting member 12B connected to the center pin body 5a at a cathode electrode-side end thereof. It is to be noted that the connecting member 12B is formed by using an electrically insulating material as has been described earlier.

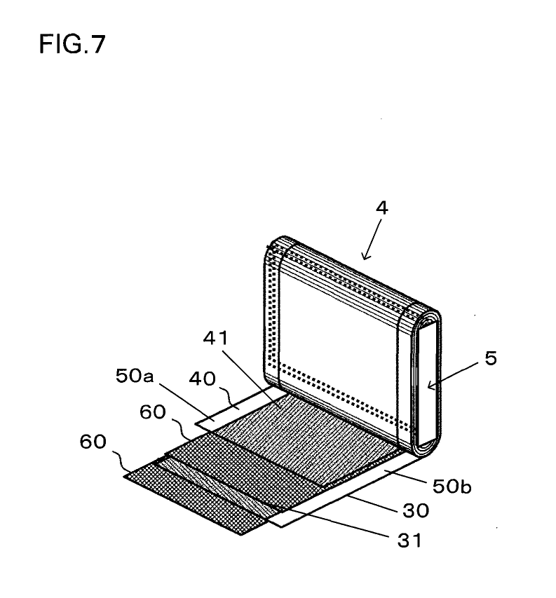

A winding body 4 wraps around a cathode foil (cathode film) 40 and an anode foil (anode film) 30 in a flat coil form with a separator 60 disposed between the cathode and anode foils 40 and 30 around the center pin 5, as shown in FIG. 7. The cathode foil 40 and the anode foil 30 respectively include electrode layers 41 and 31 formed by applying active material composites onto a cathode collector foil and an anode collector foil. A cathode collector portion 50a and an anode collector portion 50b with no active material composites coating present thereupon are formed at the cathode foil at one end thereof along the widthwise direction (the direction perpendicular to the winding direction) and at the anode foil at another end thereof along the widthwise direction. The cathode collector portion 50a and an anode collector portion 50b are thus formed at positions facing opposite each other along the width of the winding body 4 (along the direction in which the center pin extends).

The center pin body 5a is formed by using a metal assuring good thermal conductivity, such as copper, and is electrically insulated via the separator 60 from the cathode and anode collector portions 50a and 50b at the cathode and the anode foils 40 and 30 of the winding body 4. The center pin body 5a is not connected to the cathode and the anode foils 40 and 30 and functions as a thermal conductor.

As shown in FIG. 6, the heat sink 8 is also formed by using a metal assuring good thermal conductivity such as copper, as is the center pin body 5a. The heat sink 8 is formed so as to achieve a roughly U-shaped section so as to achieve full contact with the inner side surfaces of the angular battery container of box type 22, and is connected with the center pin body 5a over the recessed area.

As shown in FIG. 4, the cathode connecting member 11 is connected to the cathode terminal 23, whereas the anode connecting member 21 is connected to the anode terminal 24. In addition, the cathode connecting member 11 and the anode connecting member 21 respectively include upper flat portions 11a and 21a and lower two-pronged portions 11b and 21b extending in a two-pronged formation from the upper flat portions 11a and 21a along the downward direction. The lower two-pronged portions 11b and 21b are respectively bonded through ultrasound welding to the cathode collector portion 50a and the anode collector portion 50b at the cathode foil 40 and the anode foil 30 of the winding body 4.

The heat sink 8 and the connecting member 12B at the center pin 5 range toward the inner surface of the steel battery container of box type 22 until they directly contact the inner surface of the battery container of box type 22. Thus, heat generated inside the winding body 4 travels through the center pin 5, i.e., via the center pin body 5a and the heat sink 8, and is thus transferred to the battery container of box type 22. A high level of heat dissipation performance is thus assured. In addition, the extent of any vibration of the winding body 4 that may occur within the battery container of box type 22 can be minimized.

An integrated system constituted with a plurality of batteries achieved in any of the embodiments described above can be configured without being subjected to restrictions with respect to the positional arrangement of the batteries.

Since there is no need to directly cool the electrode terminals, the cathode and anode terminals will not be corroded or there will be no risk of electrical shorting caused by electrically conductive matter adhering onto the insulating areas.

Even in an operating environment in which the output fluctuates significantly or an operating environment where steep electrical charge/discharge is repeated, good heat absorption response (velocity) is assured and the battery temperature can be sustained at the optimal level.

In other words, by adopting any of the embodiments, it can be ensured that heat generated inside the container be efficiently transferred to the container without having to drastically alter the battery structure and that since a large heat dissipation area is created, deterioration of the battery characteristics attributable to high temperature is prevented, to achieve an extended service life. Furthermore, since the rise in battery temperature during electrical charge/discharge is minimized, the service life of the battery is further extended.

In each of the embodiments of the present invention, a thermally conductive member is disposed to range from the center pin at the winding body to the heat dissipation portion of the container and the thermally conductive member is formed so that its heat transfer area becomes larger as it ranges closer to the heat dissipating portion of the container. As a result, heat generated inside the container be transferred to the container with great efficiency and the heat can then be released to the outside from the heat dissipating portion of the container.

Each of the embodiments may include an external cooling means as an additional member so as to achieve pinpoint cooling in the area at which the heat sink is mounted and prevent corrosion or electrical shorting attributable to electrically conductive matter adhering to the heat sink.

Through any of the embodiments described above, the temperature of the winding body is controlled so that it does not rise above the optimal range during electrical charge/discharge and thus, degradation of the battery characteristics caused by an excessive temperature increase can be prevented.

Since heat generated through chemical reactions between the electrolyte and the active materials under abnormal conditions at the battery, such as an excessive electrical charge, can also be released through the heat dissipating portion of the container, the container be sustained in a sound condition.

The present invention relates to a lithium-ion secondary battery that will prove particularly useful as a large battery in automotive applications and electric power storage applications.

The above described embodiments are examples and various modifications can be made without departing from the scope of the invention.

What is claimed is:

1. A lithium-ion secondary battery, comprising:
a winding body in a coil formation at a battery container, the winding body wrapping a cathode film in which lithium ions store and from which lithium ions extract and a anode film in which lithium ions store and from which lithium ions extract, and the cathode film and the anode film being electrically separated from each other via a porous separator; and
a heat sink disposed inside the battery container, which contacts the battery container and transmits heat inside the winding body to the battery container.

2. A lithium-ion secondary battery according to claim 1, further comprising:
a center pin constituted of a material similar to a material constituting the heat sink, which is located at a center of the winding body.

3. A lithium-ion secondary battery according to claim 2, further comprising:
an anode collector ring disposed between the center pin and the heat sink, constituted of a material similar to the material constituting the center pin and the heat sink, and connected to an anode tab.

4. A lithium-ion secondary battery according to claim 3, wherein:
an area over which the heat sink contacts the anode collector ring is greater than an area over which the center pin contacts the anode collector ring.

5. A lithium-ion secondary battery according to claim 1, further comprising:
a top cap connected, via an electrically insulating packing, to the battery container; and
a cathode collector ring electrically connected to the top cap via a cathode connecting member and connected to a cathode tab.

6. A lithium-ion secondary battery according to claim 5, further comprising:
an electrically insulating connecting ring that is connected to the cathode collector ring and the center pin.

7. A lithium-ion secondary battery according to claim 1, further comprising:
a center pin located at a center of the winding body and constituted of a material with a high coefficient of thermal conductivity, wherein:
the center pin and the heat sink are connected.

8. A lithium-ion secondary battery according to claim 7, wherein:
the cathode film, the anode film and the separator wind around the center pin.

9. A lithium-ion secondary battery, comprising:
a winding body that wraps a cathode film and an anode film via a separator, the cathode film including electrode layers and a cathode collector portion with no electrode layer formed thereat disposed on a side along a widthwise direction, the anode film including electrode layers and an anode collector portion with no electrode layer formed thereat disposed on another side along a widthwise direction, and the separator electrically separating the cathode film and the anode film from each other;
a battery canister accommodating the winding body, which includes an anode external terminal connected with the anode collector portion and a cathode external terminal connected with the cathode collector portion;
a center core ranging at a central area of the winding body; and
a heat sink disposed at one end of the center pin and connected to an inner surface of the battery canister.

10. A lithium-ion secondary battery according to claim 9, further comprising:
an insulating member disposed at another end of the center pin and connected to the inner surface of the battery canister.
